(19) United States
(12) Patent Application Publication
(10) Pub. No.: US 2016/0324179 A1
(43) Pub. Date: Nov. 10, 2016

(54) PRETREATMENT PROCESS OF GREEN COFFEE BEANS FOR IMPROVING AROMA AND TASTE OF ROASTED COFFEE

(71) Applicant: UNIVERSITY-IN-DUSTRY COOPERATION GROUP OF KYUNG HEE UNIVERSITY, Yongin-si (KR)

(72) Inventor: Seung Kook PARK, Yongin-si (KR)

(21) Appl. No.: 15/108,036

(22) PCT Filed: Dec. 26, 2014
(86) PCT No.: PCT/KR2014/012907

§ 371 Date: Jun. 24, 2016

(30) Foreign Application Priority Data
Dec. 27, 2013 (KR) 10-2013-0166091

(51) Int. Cl. A23F 5/02

(52) U.S. Cl. CPC A23F 5/02

(57) ABSTRACT

The present invention relates to a method for pretreating green coffee beans before roasting to improve flavor and taste of coffee; green coffee beans pretreated by the method; a method for preparing a coffee extract including extracting the thus-prepared green coffee beans with hot-water; and a coffee extract prepared by the method.

According to the pretreatment method of the present invention, coffee can be prepared with improved taste and flavor, increased extraction efficiency, and a reduced amount of carcinogenic materials, and thus the method of the present invention can be widely applied in the coffee industry.

### TECHNICAL FIELD

The present invention relates to a method for pretreating green coffee beans before roasting to improve flavor and taste of coffee; green coffee beans pretreated by the method; a method for preparing a coffee extract including extracting the thus-prepared green coffee beans with hot-water; and a coffee extract prepared by the method.

### BACKGROUND ART

Coffee is a popular drink and is the most widely distributed and consumed drink in the world. It is sold or consumed in the form of instant coffee, mixed coffee, canned coffee, and brewed coffee. Green coffee or green coffee beans refers to dried seeds of the coffee cherries, which are obtained by removing the pericarp and the pulp of the coffee cherries followed by drying, upon harvesting. The green coffee beans are prepared into powder (i.e., roasted and ground coffee) by roasting and grinding, and added with hot water to obtain a liquid extract containing the ingredients present in the powder, which is the brewed coffee we drink.

Coffee is cultivated in areas located from latitude 25° south to latitude 25° north, the so-called coffee zone or coffee belt, and its flavor is known to vary according to various factors, such as coffee species, characteristics of cultivation areas, methods of cultivation, weather conditions, methods of harvesting, methods of drying, roasting, grinding, etc.

Coffee species are largely classified into Arabica coffee (Coffea arabica) and Robusta coffee (Coffea canephora). Arabica coffee, which is mainly cultivated in cool alpine areas with an altitude of 800 m or higher in South America, Central America, and some African countries such as Ethiopia, accounts for about 65% of the global coffee production. Arabica coffee is a premium quality coffee with excellent flavor quality and a harmony of pleasant sour taste and bitter taste, and thus is used in premium brew coffeehouses. On the other hand, Robusta coffee accounts for about 35% of the global coffee production, and is cultivated in high-temperature and high-humidity areas with an altitude of 600 m or lower in Southeast Asia, such as Vietnam, India Indonesia, Thailand, etc., and most African countries, such as Uganda, Republic of the Cote d'Ivoire, etc. Robusta coffee has a less desirable flavor with a harsh and strong rubber-burning smell, a weak sour taste and a strong bitter taste, and is cheap, and thus is mainly used as a raw material for instant coffee or thick espresso. While, Brazil produces 30% or more of global coffee production, and among them. Arabica coffee accounts for 80%. However, 20% or more of the total production of Brazilian coffee, although they are Arabica coffee, has been poorly evaluated due to the presence of a particular odor, the so-called “Rioy defect”, characterized by an acrid and powerful off-odor or strong phenolic, medicinal antiseptic-type smell.

In particular, green coffee beans can be dried largely by a dry processing method and a wet processing method. The dry processing method, which is also called the natural drying method, proceeds with roughly a three-step process (washing-drying-peeling). The dry processing method includes removing impurities from the coffee fruits harvested in areas with insufficient water but with good sunlight, washing the coffee fruits with flowing water, primarily drying in spacious areas with the full sunlight for about from 2 weeks to 4 weeks according to the weather conditions, removing the dried cherry fruit flesh, and drying the resultant so that the final water content of the seeds can be in the range from 10% to 12%. The dry processing method is widely used in Brazil, Ethiopia, Ecuador, Indonesia, Vietnam, etc. The wet processing method, which is also called washing and drying method, includes removing the epicarp of the coffee fruits using a mechanical device, removing the mucilage covering the endocarp via natural fermentation by soaking in water for 10 hours to 24 hours, washing to adjust the average water content to about 57%, drying by hot air drying or natural drying so that the average water content to be about from 10% to 13%. Such a wet processing method requires many facilities and labor, however, the quality of green coffee beans prepared by the method is known to have a higher quality than the quality of those prepared by the dry processing method. In Colombia, Jamaica, Hawaii, and Guatemala, etc., premium Arabica coffee is produced using the wet processing method. The dried coffee is stored/maintained in the state of parchment green beans removed from epicarp in a polishing factory, and at the time of sales, the endocarp is removed and the green coffee beans are classified according to the size after sorting out defective green coffee beans, packed, and sent out for sales.

Roasting, which is an important step in a coffee processing procedure, is a process of applying heat on green coffee beans until appropriate color and flavor develop, and various physicochemical reactions that can determine the quality of final brewed coffee during the process. During the roasting process, a rapid expansion occurs inside the green coffee beans due to the pressure caused by water and carbon dioxide along with a chemical reaction the heat applied thereon, and part of the volatile components generated therein become volatilized to the outside. Coffee aroma is the most important factor in coffee quality, and the low molecular weight saccharides and amino acids or proteins present in green coffee beans react alone or with each other by the heat treatment (these reactions are classified into three different types of reactions; Caramellization, Maillard reaction, and Strecker degradation) and generate a few hundred kinds of volatile aromatic materials. As such, coffee can have various tastes and flavors according to the species, areas of production, drying methods, roasting methods, etc., and thus, continuous studies are conducted on the methods of cultivation, processing of green coffee beans, roasting, etc., for the improvement of coffee flavors.

Although Robusta coffee has low quality flavor and taste, it grows well in areas under 600 m in elevation instead of high alpine regions, tolerates well drought, is resistant to damages by diseases and insects, and enables mechanization thus having a 2- to 3-fold higher harvest compared to that of Arabica. However, Robusta coffee has problems in that it has a 2-fold higher caffeine content than that of Arabica (1.7% to 2.5%), has a weak or harsh flavor, and in the case of light roasting, it often releases a earthy smell, a fungus smell, a beany smell, and has a bitter and astringent taste. In the case of a mild or dark roasting, as a way to solve the problems, Robusta coffee has a problem in that it releases a very strong taste of bitterness and astringency along with a pungent rubber-burning smell. Additionally, in the case of dark roasting, a large amount of carcinogens, such as acrylamide, furan, etc., can be generated due to carbonization. Reportedly, coffee contains the highest amount of furan among the foods.

Furan is known to be produced by pyrolysis of saccharides or amino acids and thermal oxidation of polyvalent unsaturated fatty acids or vitamin C, during the roasting process. To solve the problem, large coffee manufacturing companies, such as Nestle and Kraft, have focused their studies on the processes and methods for improving the quality of Robusta coffee. However, they have not yet found any fundamental solution to the problem.

Attempts to improve the flavors of Robusta coffee were already initiated in early 1970s (U.S. Pat. No. 3,640,726), and the American General Foods Corporation (the current U.S. Kraft Foods Group, Inc.) developed a technology for roasting to remove the rough and bitter taste of Robusta coffee by drying the green Robusta coffee beans after steaming them under high temperature and high pressure (U.S. Pat. No. 4,540,591) in 1985. Additionally, in 1991, the Swiss Jacobs Suchard (the current U.S. Kraft Foods Group, Inc.) developed a method for reducing the “earthy smell” and “fungi smell” of Robusta coffee to improve the quality of the Robusta coffee flavor by increasing the water content of the raw Robusta coffee beans to a range from 30% to 45% under high pressure (3 atm. to 4 atm.) with steaming at a temperature from 135° C. to 140° C. (U.S. Pat. No. 5,019,413). However, these two representative methods for treating green Robusta coffee beans under high-temperature and high-pressure steaming have disadvantages in that they require a large-scale steam-generating apparatus under high-temperature and high-pressure and release off-flavors along with the cooked beany smell due to the pyrolysis of green coffee beans by heat treatment at high temperature, and thus other types of off-flavors may be generated although the original off-flavors of Robusta coffee may be reduced.

Additionally. Japanese Application Publication No. 2003-009767 discloses that when green coffee beans are added with 2.5 to 10 times of water relative to the weight of the green coffee beans at from 10° C. to 60° C. and soaked therein at the same water temperature for 4 hours to 24 hours, the flavor of the green coffee beans can be improved. Additionally, International Publication No. WO 2008-029578 discloses a method for germinating fresh coffee beans, which includes sufficiently immersing the green coffee beans in water at a temperature from 5° C. to 50° C., maintaining the water temperature at a temperature from 20° C. to 40° C. for the germination of the green coffee beans, washing impurities from the germinated green coffee beans with water, and drying the green coffee beans to have a water content of about 11%. However, these two methods have a serious problem in that the immersion of a large amount of the green coffee beans in warm water for a long period of time results in the loss of a large amount of low molecular weight water-soluble flavor precursors such as saccharides (i.e., sucrose, glucose, and fructose) and water-soluble amino acids, which are very important for the expression of coffee flavors during the roasting process, thus deteriorating the development of coffee flavors.

Additionally, the temperature range (20° C. to 40° C.) for immersing the green coffee beans can cause a serious problem in terms of sanitation and safety in that a large amount of nutrients are leached out from the immersed green coffee beans, thus providing a condition suitable for the growth of molds which produce ochratoxin A, a highly toxic carcinogen.

Additionally, Korean Pat. No. 10-1060203 discloses a method for preparing coffee with good flavor by steaming the green coffee beans at a temperature from 90° C. to 106° C. for 5 hours to 9 hours, drying the resultant at a temperature from 50° C. to 70° C. for 12 hours to 24 hours, and age the resultant beans at room temperature for 1 day to 7 days. Additionally, Korean Pat. No. 10-1448184 discloses a method which can increase the γ-aminobutyric acid (GABA) content by completely immersing the green coffee beans by adding magnetized water to a water tank equipped with a thermostat and germinating at a temperature from 40° C. to 85° C. for 3 hours to 9 hours. However, both methods include a process of immersing green coffee beans into an excess amount of hot water for 4 hours to 24 hours, and flavor components are generated during the roasting process, and it is unavoidable that a large amount of water-soluble flavor precursors such as saccharides and amino acid materials, which are essential for the expression of coffee flavors during the roasting process, is lost, and thus the amount of good flavors is absolutely lowered during the roasting step thereby becoming fatal to the quality of the coffee produced therefrom.

U.S. Application Publication No. 2009-0220645, which relates to a method for preparing the green coffee beans with flavor characteristic similar to that of “Kopi Luwak”, which is in vogue at present, includes adding an enzyme capable of decomposing the components of the green coffee beans in a state where the green coffee beans are submerged to a hydrochloric acid bath with a pH 1.7, thereby decomposing the saccharides and the proteins contained in the green coffee beans at a temperature from 30° C. to 45° C. for a maximum of 24 hours, drying, followed by roasting. However, the method is very inappropriate to be utilized in reality because the submerging of the green coffee beans in strong hydrochloric acid would trigger a negative customer reaction due to the use of a chemical agent and also, there is a problem in that a large amount of flavor precursor materials, which are important for the expression of coffee flavor, can be lost by the use of hydrochloric acid.

### DISCLOSURE

### Technical Problem

The present inventor has endeavored to develop a method for resolving the problems described above and improving flavors and tastes of coffee, and as a result, have discovered that roasting the green coffee beans after pretreating them can improve flavors and tastes of coffee, increase extraction efficiency, and reduce the amount of carcinogens, thereby completing the present invention.

### Technical Solution

An object of the present invention is to provide a method for pretreating green coffee beans, including: germinating water-absorbed green coffee beans in an incubator or a dark room at a temperature from 10° C. to 20° C. or from 40° C. to 60° C. for 1 day to 3 days; and drying the green coffee beans germinated in step (a).

Another object of the present invention is to provide a method for pretreating green coffee beans, including: germinating the water-absorbed green coffee beans in an incubator or a dark room at a temperature from 10° C. to 20° C. for 1 day to 3 days; germinating the green coffee beans that went through with step (a) in an incubator or a dark room at a temperature from 40° C. to 60° C. for 1 day to 3 days; and drying the green coffee beans germinated in step (b).

Still another object of the present invention is to provide green coffee beans pretreated by the above method.

Still another object of the present invention is to provide a method for preparing a coffee extract including extracting the green coffee beans with hot-water.

Still another object of the present invention is to provide a coffee extract prepared by the above method of preparing the coffee extract.

### Advantageous Effects of the Invention

According to the pretreatment method of the present invention, the method can reduce the rough and strong smells of low quality coffee, in particular, a Robusta species coffee, increase the desirable aroma while reducing bitter taste and increasing sour taste, thereby significantly improving the taste. Additionally, in the case of Brazilian coffee, which is an Arabica coffee, the taste quality can be improved by increasing the sweet and nutty flavors while reducing the bad smell of a disinfectant. Accordingly, the method of pretreating green coffee beans of the present invention can improve the taste and flavors, increase extraction efliciency, and prepare coffee with a reduced amount of carcinogens, and thus can be widely applied to coffee industry.

### BRIEF DESCRIPTION OF THE DRAWINGS

FIG. 1 shows a chart comparing the methods for pretreating green coffee beans until hot air drying in Preparation Examples 1 to 5.

FIG. 2 shows the representative results of analysis of volatile aroma components of Robusta coffee (Vietnam), obtained in the present invention, performed using the Gas chromatography-Flame Ionization Detector (GC-FID). Specifically, (A) represents the control group, (B) represents coffee obtained by low temperature germination, and (C) represents coffee obtained by enzyme-added germination. The components corresponding to each peak are analyzed in Table 1.

FIG. 3 shows the representative results of analysis of volatile aroma components of Arabica coffee (Brazil), obtained in the present invention, performed using the Gas chromatography-Flame Ionization Detector (GC-FID). Specifically, (A) represents the control group. (B) represents coffee obtained by low temperature germination, and (C) represents coffee obtained by enzyme-added germination. The components corresponding to each peak are analyzed in Table 2.

FIG. 4 shows the images of roasted Robusta coffee (Vietnam) at 300× magnification under an electron microscope.

FIG. 5 shows the images of roasted Arabica coffee (Brazil) at 500× magnification under an electron microscope.

### BEST MODE OF APPLICATIONS INVENTED

An aspect of the present invention provides a method for pretreating green coffee beans before roasting for the improvement of aroma and taste of coffee. Specifically, the method for pretreating green coffee beans may include (a) germinating the water-absorbed green coffee beans in an incubator or a dark room at from 10° C. to 20° C. or 40° C. to 60° C. for 1 day to 3 days; and drying the green coffee beans germinated in step (a).

The method of pretreating green coffee beans of the present invention can improve aroma and taste quality of coffee and reduce carcinogens and thus can be effectively used in the coffee industry.

As used herein, the term “green coffee or green coffee beans” generally refers to coffee beans taking on a green color, that is, the coffee in a state obtained from coffee cherries by a wet process, a dry process, etc., but the method to obtain the coffee is not limited thereto as long as the germinability can be maintained.

Germination of all species is affected by temperature, moisture content, oxygen, and sunlight, and among them, moisture content and temperature are considered to be most important. During the early process of germination, various kinds of enzymes are biosynthesized and activated, and polymer materials such as proteins and polysaccharides are decomposed into smaller units of peptides and amino acids, and oligosaccharides or monosaccharides, etc. Additionally, in the case of green coffee beans, many phenolic compounds, which are different from the original compounds, are produced by enzymatic or chemical reactions. The present inventor has discovered that the production of new compounds and changes therein by all biochemical or chemical reactions occurring during the early germination process eventually become the precursors of good volatile aroma components developed while roasting green coffee beans, and simultaneously the components of bitter taste become reduced, thereby completing the present invention.

The present invention increased the precursors capable of expressing good aroma components during the coffee-roasting process and simultaneously reduced the precursors for generating bad odors or bitter taste, thereby improving flavor and taste quality of coffee.

Unlike the conventional method of soaking green coffee beans in an excess amount of hot water, the pretreating method of the present invention is a method for germinating green coffee beans by allowing a suitable amount of water for germination to be absorbed into the green coffee beans, and the loss of a large amount of low molecular weight flavor precursors, i.e., saccharides (e.g., sucrose, glucose, fructose, and water-soluble amino acid materials), can be prevented, thereby improving aroma and taste of coffee.

In the present invention, the water content of the water-absorbed green coffee beans in step (a) belongs to the scope of the present invention as long as the water content is sufficient for the germination of green coffee beans, and specifically, water may be absorbed in the range from 40% to 60% relative to the total weight of the green coffee beans, and more specifically, from 45% to 55%, but is not limited thereto.

Additionally, specifically, the incubation temperature in step (a) may be in the range from 12° C. to 20° C. or from 40° C. to 58° C., but is not limited thereto.

Additionally, in the present invention, the water temperature of the water-absorbed green coffee beans in step (a) will belong to the scope of the present invention as long as green coffee beans can be germinated thereat, and specifically, the temperature may be 15° C. to 25° C., but is not limited thereto.

In step (a) of the pretreatment method of the present invention, the purpose of allowing the green coffee beans to absorb water to have a water content in the range from 40% to 60%, followed by germinating the water-absorbed green coffee beans in an incubator maintained at from 10° C. to 20° C. or 40° C. to 60° C. for 1 day to 3 days was for preventing the major germination process while allowing the initiation of the biochemical metabolism for the early germination of green coffee beans at an appropriate level, and furthermore, for avoiding the temperature range of from 20° C. to 40° C., which is the most suitable temperature for the proliferation of bacteria or fungi. Accordingly, regarding the degree of germination in step (a), it is sufficient that radicals slightly pop out of the green coffee beans, or there is a movement of germination by the enzyme action of the green coffee beans themselves inside the green coffee beans. Conventionally, the germination rate that can be achieved in the present invention may be in the range from 50% to 80%, but is not limited thereto.

The green coffee beans immediately processed upon harvest generally have 90% or higher of germination rate. However, the germination rate of green coffee beans varies a lot depending on the states of the harvested coffee cherries, and conditions of processing and storage. In particular. Robusta coffee is mostly grown in African countries or Asian regions under poor growth conditions with hot and humid weather. Therefore, the vitality of green coffee beans is deteriorated during the storage period after bean processing. Furthermore, since the green coffee beans must go through with the sea transport under a hot and humid environment until they arrive at the final place for consumption, the germination rate of green coffee beans will be rapidly deteriorated, thus the production of flavor precursors via germination process may not be sufficient.

Accordingly, the present invention may be performed by adding an enzyme for effective decomposition of the various constituting components of the endosperm of green coffee beans, which are difficult to germinate due to the deterioration in vitality. In the case of adding such an enzyme, the method of pretreatment of the present invention may be performed by adding an appropriate amount of an enzyme to water to be absorbed into green coffee beans in step (a) and allowing the green coffee beans to absorb the enzyme solution using the water for incubation. Additionally, low-temperature germination and enzyme-added germination may be performed in series depending on the types of green coffee beans and the environment. The enzyme-added germination refers to performing germination by adding an enzyme to green coffee beans.

The non-limiting example of the enzymes to be absorbed into green coffee beans may include protease, carbohydrase, armvlase, glucosidase, dextranase, mannase, etc., and a complex enzyme containing at least one of these enzymes may also be used.

The pH range of water, to which the enzyme is added in the present invention, may not be limited as long as the enzyme can exhibit its activity in the given pH range, and specifically, the pH range may be from pH 3.0 to pH 8.0 in which the flavor precursors important for the expression of coffee flavors are not significantly lost, but is not limited thereto.

Additionally, at least one flavor precursors of green coffee beans selected from the group consisting of sucrose, glucose, and fructose, may be added to water before green coffee beans absorb water so that at least one selected saccharide is absorbed into the water-absorbed green coffee beans, in step (a) of the present invention, and specifically, the flavor precursors may be added in an amount of from 0.05% to 30% relative to the total weight of green coffee beans, and more specifically, from 0.1% to 15%, but is not limited thereto.

Additionally, in step (a), sucrose, glucose, and fructose, which are the flavor precursors of green coffee beans, for being absorbed into the green coffee beans may be added into water with a mixed weight ratio of 1 to 6:1 to 6:1 to 6 relative to the weight, and specifically 3:1:1, but is not limited thereto.

In an exemplary embodiment of the present invention, 200 g of green coffee beans washed by a conventional water washing process were added into a zipper bag and then 150 mL of drinking water at from 15° C. to 25° C. was poured thereinto, and the water content of the green coffee beans was adjusted in the range from 40% to 60% (about 50%) relative to the total weight of the green coffee beans. After sealing, the zipper bag was placed in a 15° C. incubator for from 24 hours to 72 hours for the germination of the green coffee beans. During the germination, the green coffee beans were pretreated by frequently opening the zipper bag to supply oxygen necessary for germination (Preparation Example 1).

Additionally, in an exemplary embodiment of the present invention, 200 g of green coffee beans washed by a conventional water washing process were added into a zipper bag and then 150 mL of drinking water at from 15° C. to 25° C., in which a complex enzyme containing protease and carbohydrase was contained in an amount of 0.2% relative to the total weight of the green coffee beans, was poured thereinto and mixed well, and the water content of the green coffee beans was adjusted in the range from 40% to 60% (about 50%) relative to the total weight of the green coffee beans. Then, the complex enzyme was absorbed into the green coffee beans. After sealing, the zipper bag was placed in a 55° C. incubator for 24 hours to 48 hours for the germination of the green coffee beans. During the germination, the green coffee beans were pretreated by frequently opening the zipper bag to supply oxygen necessary for germination (Preparation Example 2).

Additionally, the method for pretreating green coffee beans of the present invention may include: (a) germinating the water-absorbed green coffee beans in an incubator or a dark room at 10° C. to 20° C. for 1 day to 3 days; (b) germinating the green coffee beans germinated in step (a) in an incubator or a dark room at 40° C. to 60° C. for 1 day to 3 days; and drying the green coffee beans germinated in step (b).

In step (a), the green coffee beans are allowed to absorb water so that the water content of the green coffee beans can be in the range from 40% to 60% relative to the total weight, and more specifically from 45% to 55%, but is not limited thereto.

In the present invention, the water content of the water-absorbed green coffee beans in step (a) will belong to the scope of the present invention as long as the water content is sufficient for the germination of green coffee beans, and specifically, water may be absorbed in the range from 40% to 60% relative to the total weight of the green coffee beans, and more specifically, from 45% to 55%, but is not limited thereto.

Additionally, the culture temperature may be in the range from 12° C. to 20° C. in step (a) or from 40° C. to 58° C. in step (b), but is not limited thereto.

Additionally, the method of the present invention may be performed by adding an enzyme which can effectively decompose the various components in the endosperm of green coffee beans. In the case of adding the enzyme, regarding the pretreatment method of the present invention, the green coffee beans may be cultured in step (a) using water, which is to be absorbed to the green coffee beans, by adding an appropriate amount of an enzyme thereto; or in step (b), by adding an appropriate amount of an enzyme to the green coffee beans, which went through step (a), and allowing the enzyme solution to be absorbed into the green coffee beans. Additionally, specifically, the green coffee beans may be cultured at a temperature from 50° C. to 60° C. by adding the green coffee beans, which went through step (a), in step (b) and allowing the enzyme solution to be absorbed into the green coffee beans. The non-limiting examples of the enzyme and the pH range of the water to which the enzyme is added are the same as described above.

Additionally, in the present invention, at least one flavor precursor of green coffee beans, which is selected from the group consisting of sucrose, glucose, and fructose, may be added to be absorbed into the green coffee beans, and specifically, the flavor precursor may be added in an amount of from 0.05% to 30% relative to the total weight of the green coffee beans, and more specifically from 0.1% to 15%, but is not limited thereto.

Additionally, in step (a), sucrose, glucose, and fructose, which are the flavor precursors of green coffee beans, for being absorbed into the green coffee beans may be added into water with a mixed weight ratio of 1 to 6:1 to 6:1 to 6 relative to the weight, and specifically 3:1:1, but is not limited thereto.

In an exemplary embodiment of the present invention, 200 g of green coffee beans washed by a conventional washing process were added into a zipper bag and then 150 mL of drinking water at from 15° C. to 25° C. was poured thereinto, and the water content of the green coffee beans was adjusted in the range from 40% to 60% (about 50%) relative to the total weight of the green coffee beans. In a sealed state, as a primary treatment, the zipper bag was placed in a 15° C. incubator for 24 hours to 48 hours, added with a complex enzyme containing protease and carbohydrase prepared for the effective decomposition of the green coffee beans, in an amount of 0.2% relative to the total weight of the green coffee beans and sealed; and as a secondary treatment, placed in a 55° C. incubator for 24 hours to 48 hours for the germination of the green coffee beans. During the germination, the green coffee beans were pretreated by frequently opening the zipper bag to supply oxygen necessary for germination (Preparation Example 3).

Additionally, in an exemplary embodiment of the present invention, 200 g of green coffee beans washed by a conventional water washing process were added into a zipper bag and then 150 mL of drinking water at from 15° C. to 25° C., in which an enzyme and flavor precursor materials (sucrose, glucose, and fructose in an amount of 3 g, 1 g, and 1 g, respectively) were contained, was poured thereinto, and the water content of the green coffee beans was adjusted in the range from 40% to 60% relative to the total weight of the green coffee beans, and a complex enzyme containing protease and carbohydrase was added to the green coffee beans in an amount of 0.2% relative to the total weight of the green coffee beans to be absorbed thereinto. Then, in a sealed state, as a primary treatment, the zipper bag was placed in a 15° C. incubator for 24 hours, and as a secondary treatment, placed in a 55° C. incubator for 24 hours to 48 hours for the germination of the green coffee beans. During the germination, the green coffee beans were pretreated by frequently opening the zipper bag to supply oxygen necessary for germination (Preparation Example 4).

Additionally, in an exemplary embodiment of the present invention, 200 g of green coffee beans washed by a conventional water washing process were added into a zipper bag and then 150 mL of drinking water at from 15° C. to 25° C., in which an enzyme and flavor precursor materials (sucrose, glucose, and fructose in an amount of 6 g, 2 g, and 2 g, respectively) were contained, was poured thereinto, and the water content of the green coffee beans was adjusted in the range from 40% to 60% relative to the total weight of the green coffee beans, and a complex enzyme containing protease and carbohydrase was added to the green coffee beans in an amount of 0.2% relative to the total weight of the green coffee beans to be absorbed thereinto. Then, in a sealed state, as a primary treatment, the zipper bag was placed in a 15° C. incubator for 24 hours, and as a secondary treatment, placed in a 55° C. incubator for 24 hours to 48 hours for the germination of the green coffee beans. During the germination, the green coffee beans were pretreated by frequently opening the zipper bag to supply oxygen necessary for germination (Preparation Example 5).

In the present invention, the pretreated green coffee beans may be used for roasting after drying. Specifically, the green coffee beans may be dried so that the water content of the green coffee beans can be in an amount of from 8%0/to 14%, but is not limited thereto. Additionally, specifically, the temperature suitable for drying is in a range from 35° C. to 70° C., and more specifically, from 50° C. to 60° C., but is not limited thereto.

In an exemplary embodiment of the present invention, a pretreated green coffee beans sample was well spread over an aluminum tray and placed in a 55° C. incubator with hot air drying oven and dried until the water content of the green coffee beans reached a range from 10% to 12% (Preparation Example 1).

The green coffee beans, which were pretreated by the pretreatment method of the present invention, can be prepared into coffee through processes such as roasting (at 230° C. to 240° C. for 6 min to 15 min). During the roasting process performed at 200° C. or higher, a large amount of gas generated inside the green coffee beans due to the reactions of organic compounds, such as saccharides and amino acids, along with the water vapor pressure by high heat is released, thereby increasing the pressure. In this regard, during the roasting process, honeycomb-shaped porous structures are formed inside the beans by the rapid change in pressure therein, and carbon dioxide and flavor components are stored inside the numerous pores. Accordingly, the shape and the size of pores are closely related to the preservation of coffee flavor components and extraction efficiency. That is, as the pore size becomes more uniform and the number of pores increases the amount of flavor preservation increases, and as the thickness of pore wall becomes thinner the extraction efficiency becomes higher.

The green coffee beans which underwent the pretreatment of the present invention have uniform pores and an increased number of pores when roasted compared to that of the control group, and thus can capture more flavor components thereby improving both aroma and taste of coffee. The green coffee beans have thinner walls compared to the control group and thus extraction efficiency can be increased and very effectively used in the coffee industry.

Additionally, the method of the present invention may further include washing the green coffee beans before the green coffee beans are allowed to absorb water, and this is for removing impurities, bacteria, fungi, etc., on bean surfaces, which can be harmful to humans, and the washing process may be performed, for example, in such a manner of washing with a brush under the flowing water with a certain degree of pressure, for 2 minutes to 5 minutes, although not particularly limited thereto.

Additionally, the method of the present invention may further include sterilizing green coffee beans before the green coffee beans are allowed to absorb water, and this may be performed using the conventional UV, low temperature plasma, etc., either alone or in combination, although not particularly limited thereto.

In an exemplary embodiment of the present invention, green coffee beans were pretreated according to the methods of Preparation Examples 1 to 5 using Robusta coffee (product of Vietnam) or Arabica coffee (product of Brazil), roasted, and the volatile flavor components were compared and analyzed. As a result, the Robusta coffee species showed increases in the sweet and nutty malty flavor and chocolate flavor, 3-methyl butanal (peak no. 4) and 2-methyl butanal (peak no. 5), in the direction from the control group (A) to low-temperature germination (B), enzyme-added germination (C), and enzyme-addition after low-temperature germination (D).

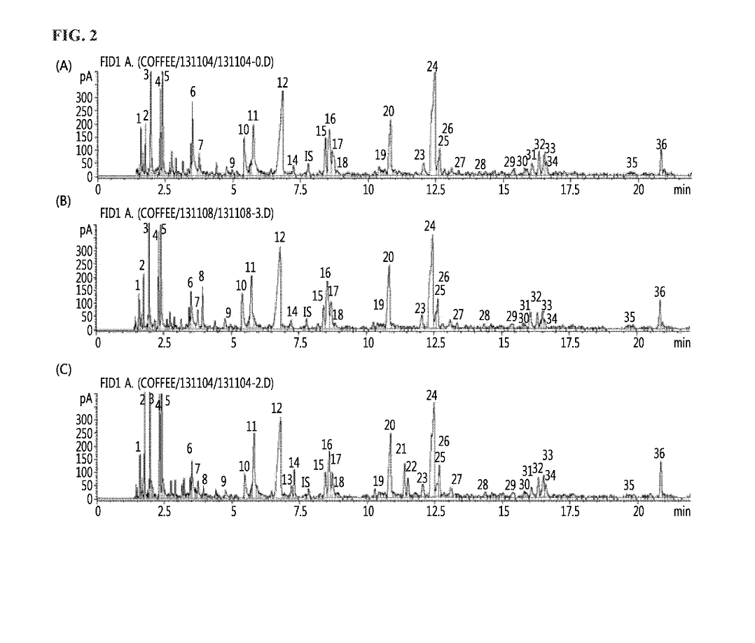

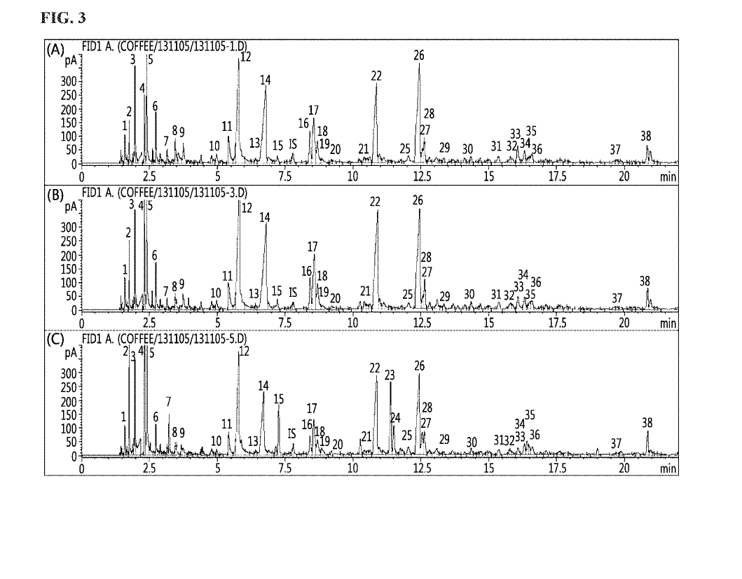

Additionally, the coffee prepared under saccharide- and enzyme-added germination (E and F) showed a significant increase in 3-methyl butanal and 2-methyl butanal compared to the control group (A) (FIG. 2 and Table 1). In particular, peak nos. 13, 21, and 22, which represent unconfirmed components, are nutty flavor components and were discovered only in the coffee prepared by enzyme treatment of Robusta green coffee beans. Additionally, all treated groups (B to F) showed a decrease in 2-methoxyphenol (peak no. 33), which is the representative compound causing a burnt smell and a disinfectant smell, in 2-furanmethanol (peak no. 12) and furfuryl alcohol (peak no. 24), which are components for a harsh odor and a bitter taste. Additionally, furan (peak no. 1), which is classified as a potential carcinogen causing a potential health risk, was significantly decreased in all treated groups (B to F) compared to the control group (A). These results could be obtained not only in Robusta coffee but also in Arabica coffee (FIG. 3 and Table 2).

From the above, it was confirmed that the coffee prepared by low-temperature germination, enzyme-added germination, enzyme addition after low-temperature germination, and saccharide- and enzyme-added germination has an increase in nutty malty and chocolate flavors, a decrease of a burnt smell, a disinfectant smell, and components for a bitter taste, and a decrease in furan, a carcinogen. Since the method of pretreating coffee of the present invention can improve flavor quality of coffee and reduce the amount of carcinogens and thus the method can be very effectively used in the coffee industry.

In an exemplary embodiment of the present invention, sensory evaluations were performed using coffee extracts from 6 different species (control group (A), low-temperature germination (B), enzyme-added germination (C), enzyme-addition after low-temperature germination (D), saccharide- and enzyme-added germination 1 (E), and saccharide- and enzyme-added germination 2 (F)) of Robusta coffee (Vietnam) in Table 1. As a result, it was confirmed that there was an increase in a nutty flavor, a sweet flavor, and a sweet taste and a sour taste which are either not present or weak in Robusta coffee, which are positive factors for flavor quality, whereas there was a decrease in negative factors, such as a harsh flavor, a rubbery smell, a bitter taste, and an astringent taste, in the direction from the control group (A) to low-temperature germination (B), enzyme-added germination (C), enzyme-addition after low-temperature germination (D), and saccharide- and enzyme-added germination (E) (Table 3). The results of these sensory evaluations were overall in line with the result of flavor analysis performed using an analytical instrument (Table 1) and the result of pH analysis which shows acidity (Table 4).

In an exemplary embodiment of the present invention, sensory evaluations were performed using coffee extracts from 6 different species (control group (A), low-temperature germination (B), enzyme-added germination (C), enzyme-addition after low-temperature germination (D), saccharide- and enzyme-added germination 1 (E), and saccharide- and enzyme-added germination 2 (F)) of Arabica coffee (Brazil) in Table 2. As a result, as is the case with the Robusta coffee, it was confirmed in Arabica coffee that there was an increase in the nutty flavor, a sweet flavor, and a sweet taste and a sour taste, which are positive factors for flavor quality, whereas there was a decrease in negative factors, such as a harsh flavor, a rubbery smell, a bitter taste, and an astringent taste, in the direction from the control group (A) to low-temperature germination (B), enzyme-added germination (C), enzyme-addition after low-temperature germination (D), and saccharide- and enzyme-added germination (E) (Table 5). The results of these sensory evaluations were overall in line with the result of flavor analysis performed using a device (Table 2) and the result of pH analysis which shows acidity (Table 6).

From the foregoing, it was confirmed that coffee prepared by low-temperature germination, coffee prepared by enzyme-added germination, coffee prepared by enzyme-addition after low-temperature germination, and coffee prepared by saccharide- and enzyme-added germination showed an increase in positive factors for flavor quality while showing a decrease in negative factors. In this regard, the method of pretreating green coffee beans of the present invention can improve both aroma and taste of coffee and thus can be very effectively used in the coffee industry.

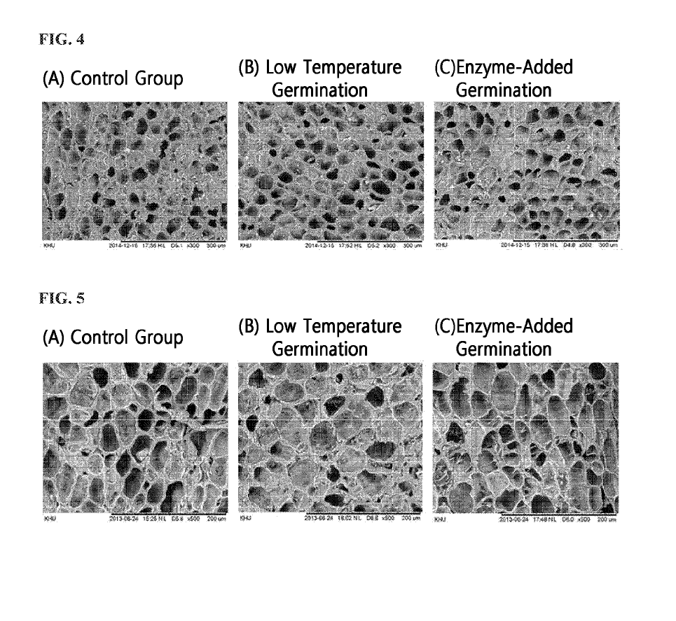

In an exemplary embodiment of the present invention, for the measurement of internal physical changes of pretreated green coffee beans, the electron microscopic images of roasted coffee after pretreatment were observed. As a result, it was confirmed that roasted Robusta coffee (Vietnam) or Arabica coffee (Brazil) have more uniform pores and thinner pore walls in low-temperature germination coffee (B) and enzyme-added germination coffee (C) compared to the control group (A) (FIGS. 4 and 5). These results indicate that the coffee samples prepared by low-temperature germination or enzyme-added germination have more uniform pores and a larger number of pores and thus can capture a larger amount of flavor components and also the thinner pore walls can provide improved extraction efficiency.

From the above, it was confirmed that coffee prepared by low-temperature germination, coffee prepared by enzyme-added germination, coffee prepared by enzyme-addition after low-temperature germination, and coffee prepared by saccharide- and enzyme-added germination have more flavor components captured therein and have improved extraction efficiency. Therefore, the method of pretreating green coffee beans of the present invention can improve both flavor and taste of coffee and also extraction efficiency, and thus can be very effectively used in the coffee industry.

In another aspect, the present invention provides green coffee beans pretreated by the method described above.

As used herein, the term “pretreated green coffee beans” refers to green coffee beans in a state where a part of the components of the green coffee beans are biochemically/chemically converted by allowing water to be absorbed into green coffee beans, followed by germination and drying. During the water absorption into green coffee beans, an enzyme which can decompose green coffee beans and a flavor precursor may be also absorbed. The green coffee beans pretreated for the purpose of the present invention have an increase of precursors of various flavor components, a decrease of a rubbery smell, which is unique to Robusta coffee, and also a decrease of bitter taste components, thereby significantly improving the flavor of the Robusta coffee. Additionally, in the case of Arabica coffee, the rio-off flavor, which is a unique smell of a disinfectant, was effectively reduced while the sweet caramel flavor and nutty flavor increased. Additionally, in the case of the Arabica coffee, the rio-off flavor unique to a disinfectant was effectively reduced, and on the contrary, the sweet caramel flavor and the nutty flavor also increased. Additionally, the pretreated green coffee beans have more uniform pores and a larger number of pores than the green coffee beans in the control group, thus having a larger amount of flavor components, and also the thinner pore walls of the pretreated green coffee beans increased the extraction efficiency.

A further aspect of the present invention provides a method for preparing a coffee extract by roasting the green coffee beans, grinding, and hot-water extraction, and a coffee extract prepared by the method.

The coffee extract may be prepared by roasting the pretreated green coffee beans, grinding, followed by an extraction with hot-water, and preferably, by a series of steps of roasting the pretreated green coffee beans, grinding, and hot-water extraction according to a conventional method. In particular, since the overall conditions, such as the degree of roasting of green coffee beans, the degree of grinding of roasted green coffee beans, a weight ratio between water and ground green coffee beans, water temperature, extraction time, etc., can vary according to the user's preference, and the extraction is preferably performed according to the conditions conventionally known in the art, although the conditions are not particularly limited thereto.

### DETAILED DESCRIPTION OF THE INVENTION

Hereinafter, the present invention will be described in more detail with reference to the following Examples. However, these Examples are for illustrative purposes only, and the invention is not intended to be limited by these Examples.

### Example 1

### Preparation of Coffee Beans Using Pretreated Green Coffee Beans

### Preparation Example 1

Green coffee beans (200 g) washed by a conventional water washing process were added into a zipper bag and then 150 mL of drinking water at from 15° C. to 25° C. was poured thereinto, and the water content of the green coffee beans was adjusted in the range from 40% to 60% (about 50%) relative to the total weight of the green coffee beans. After sealing, the zipper bag was placed in a 15° C. incubator for from 24 hours to 72 hours for the germination of the green coffee beans. During the germination, the green coffee beans were pretreated by frequently opening the zipper bag to supply oxygen necessary for germination. The thus-germinated green coffee bean sample was well spread over an aluminum spray and dried in a 55° C. hot-air drying oven to adjust the water content of the green coffee beans in the range from 10% to 12%. The thus-pretreated green coffee beans were roasted according to a conventional method. The roasting was performed using the drum-type Sample Roaster (Probat REI, Germany). When the internal temperature of the roasting drum reached 235° C., the sample (200 g) of the green coffee beans was added thereinto and roasted at an intermediate level for 11 minutes to 12 minutes (lightness, L=23 to 25: a=4: b=10 to 11).

### Preparation Example 2

Green coffee beans (200 g) washed by a conventional water washing process were added into a zipper bag and then 150 mL of drinking water at from 15° C. to 25° C., in which a complex enzyme containing protease and carbohydrase was contained in an amount of 0.2% relative to the total weight of the green coffee beans, was poured thereinto and mixed well, and the water content of the green coffee beans was adjusted in the range from 40% to 60% (about 50%) relative to the total weight of the green coffee beans. Then, the complex enzyme was absorbed into the green coffee beans. After sealing, the zipper bag was placed in a 55° C. incubator for from 24 hours to 48 hours for the germination of the green coffee beans. During the germination, the green coffee beans were pretreated by frequently opening the zipper bag to supply oxygen necessary for germination. The drying and roasting after cultivation were performed in the same manner as in Preparation Example 1.

### Preparation Example 3

Green coffee beans (200 g) washed by a conventional water washing process were added into a zipper bag and then 150 mL of drinking water at from 15° C. to 25° C. was poured thereinto, and the water content of the green coffee beans was adjusted in the range from 40% to 60% (about 50%) relative to the total weight of the green coffee beans. In a sealed state, as a primary treatment, the zipper bag was placed in a 15° C. incubator for 24 hours to 48 hours, added with a complex enzyme containing protease and carbohydrase prepared for the effective decomposition of the green coffee beans, in an amount of 0.2% relative to the total weight of the green coffee beans and sealed; and as a secondary treatment, placed in a 55° C. incubator for 24 hours to 48 hours for the germination of the green coffee beans. During the germination, the green coffee beans were pretreated by frequently opening the zipper bag to supply oxygen necessary for germination. The drying and roasting after cultivation were performed in the same manner as in Preparation Example 1.

### Preparation Example 4

Green coffee beans (200 g) washed by a conventional water washing process were added into a zipper bag and then 150 mL of drinking water at from 15° C. to 25° C., in which an enzyme and flavor precursor materials (sucrose, glucose, and fructose in an amount of 3 g, 1 g, and 1 g, respectively) were contained, was poured thereinto, and the water content of the green coffee beans was adjusted in the range from 40% to 60% (about 50%) relative to the total weight of the green coffee beans, and a complex enzyme containing protease and carbohydrase was added to the green coffee beans in an amount of 0.2% relative to the total weight of the green coffee beans to be absorbed thereinto. Then, in a sealed state, as a primary treatment, the zipper bag was placed in a 15° C. incubator for 24 hours, and as a secondary treatment, placed in a 55° C. incubator for 24 hours to 48 hours for the germination of the green coffee beans. During the germination, the green coffee beans were pretreated by frequently opening the zipper bag to supply oxygen necessary for germination. The drying and roasting after cultivation were performed in the same manner as in Preparation Example 1.

### Preparation Example 5

Green coffee beans (200 g) washed by a conventional water washing process were added into a zipper bag and then 150 mL of drinking water at from 15° C. to 25° C. in which an enzyme and flavor precursor materials (sucrose, glucose, and fructose in an amount of 6 g, 2 g, and 2 g, respectively) were contained, was poured thereinto, and the water content of the green coffee beans was adjusted in the range from 40% to 60% relative to the total weight of the green coffee beans, and a complex enzyme containing protease and carbohydrase was added to the green coffee beans in an amount of 0.2% relative to the total weight of the green coffee beans to be absorbed thereinto. Then, in a sealed state, as a primary treatment, the zipper bag was placed in a 15° C. incubator for 24 hours, and as a secondary treatment, placed in a 55° C. incubator for 24 hours to 48 hours for the germination of the green coffee beans. During the germination, the green coffee beans were pretreated by frequently opening the zipper bag to supply oxygen necessary for germination. The drying and roasting after cultivation were performed in the same manner as in Preparation Example 1.

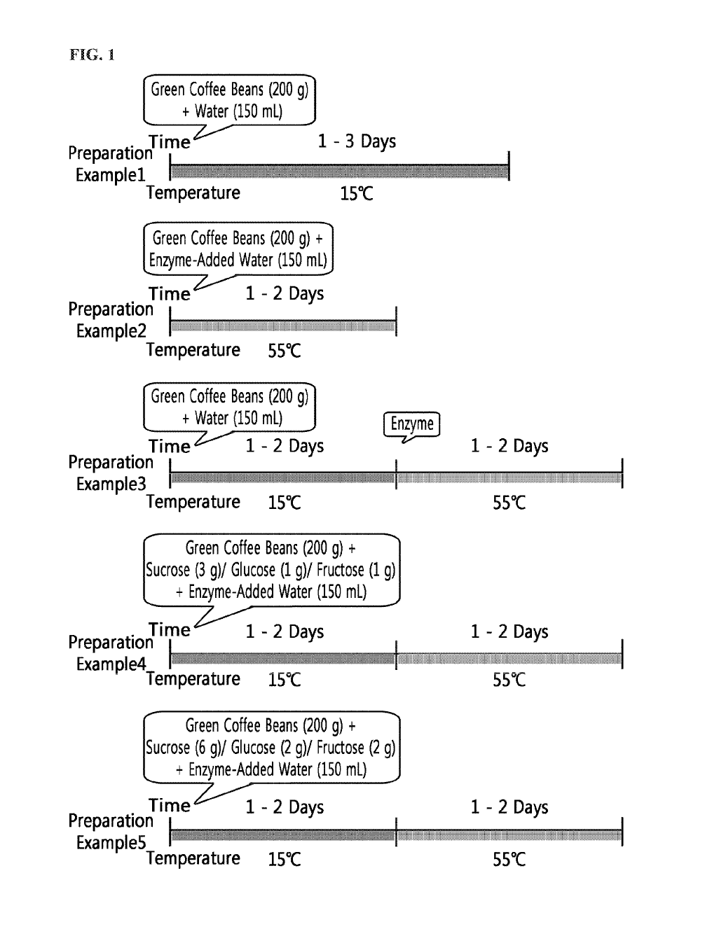

The methods of pretreating green coffee beans prior to hot-air drying illustrated in Preparation Examples 1 to 5 were compared and the results are shown in FIG. 1.

### Example 2

### Analysis and Quality Evaluation of Flavor Components

### 2-1. Measurement of Roasting Intensity

The measurement of coffee chromaticity was indicated in terms of value L (which represents lightness), value a (which represents redness), and value b (which represents yellowness) using a colorimeter after grinding the coffee beans to a medium size, and the measurement was performed 5 times repeatedly.

### 2-2. Analysis of Flavor Components of Roasted Coffee

After grinding the roasted coffee to medium-size particles, the ground coffee particles in an amount of 1 g were respectively added into 16 mL SPME (Solid Phase MicroExtraction) vials, added with 5 mL of drinking water at 35° C. closed with a lid, and the flavor components were allowed to adsorb to SPME fiber (50/30 μm DVBiCarboxen/PDMS) exposed thereto while stirring at 500 rpm in a temperature-controlled magnetic stirrer, thereby analyzing the flavor components. The analysis was performed 3 times repeatedly.

### 2-3. Result of Analysis of Flavor Components

Green coffee beans of Robusta coffee (product of Vietnam) or Arabica coffee (product of Brazil) were respectively pretreated according to the methods of Preparation Examples 1 to 5, roasted, and the volatile flavor components thereof were compared and analyzed. The content of flavor components was analyzed by GC peak area comparison, and the Robusta coffee (product of Vietnam) or Arabica coffee (product of Brazil) without any treatment were compared and analyzed after roasting. The results are shown in FIGS. 2 to 3 and Tables 1 and 2.

TABLE 1

| | | Robusta Coffee (Product of Vietnam) GC Peak Area | | | | | |
|---|---|---|---|---|---|---|---|
| | | Control | | | Prep. Ex. 3 | Prep. Ex. 4 | Prep. Ex. 5 |
| | | Group | Prep. Ex. 1 | Prep. Ex. 2 | Enzyme-addition | Sugar- and | Sugar- and |
| | | Control | Low-temp | Enzyme-added | after Low-temp | Enzyme-added | Enzyme-added |
| Peak | | Group | Germination | Germination | Germination | Germination 1 | Germination 2 |
| No. | Compound | (A) | (B) | (C) | (D) | (E) | (F) |
| 1 | Furan | 382 | 276 | 301 | 272 | 295 | 274 |
| 2 | Unknown | 311 | 297 | 451 | 380 | 298 | 297 |
| 3 | Unknown | 1237 | 729 | 984 | 745 | 941 | 771 |
| 4 | 3-Methyl butanal | 537 | 580 | 898 | 924 | 836 | 870 |
| 5 | 2-Methyl butanal | 1053 | 1284 | 1450 | 1495 | 1356 | 1392 |
| 6 | Unknown | 931 | 585 | 452 | 505 | 446 | 630 |
| 7 | Unknown | 246 | 132 | 243 | 65 | 272 | 138 |
| 8 | Unknown | — | 417 | 114 | 150 | 261 | 414 |
| 9 | Dihydro-2-methyl- | 118 | 93 | 66 | 36 | 75 | 100 |
| | 3(2H)-furanone | | | | | | |
| 10 | 2-Methyl pyrazine | 692 | 696 | 443 | 288 | 511 | 728 |
| 11 | Furfural | 950 | 1160 | 1241 | 1334 | 1279 | 1259 |
| 12 | 2-Furanmethanol | 2813 | 2515 | 2431 | 2303 | 2407 | 2442 |
| 13 | Unknown | — | — | 327 | 481 | 355 | 341 |
| 14 | 2-Furfurylformate | 625 | 417 | 454 | 391 | 381 | 390 |
| 15 | 1-(2-Furanyl)-ethanone | 1049 | 1147 | 855 | 760 | 898 | 1198 |
| 16 | 2-Ethyl pyrazine | 643 | 610 | 473 | 358 | 374 | 615 |
| 17 | 2,3-Dimethyl pyrazine | 183 | 192 | 85 | 337 | 330 | 212 |
| 18 | 3-Methyl-2-buten-1-ol | 39 | 46 | 15 | 20 | 23 | 39 |
| 19 | Benzaldehyde | 106 | 114 | 103 | 110 | 111 | 107 |
| 20 | Unknown | 1182 | 1436 | 1385 | 1263 | 1253 | 1294 |
| 21 | Unknown | — | — | 494 | 497 | 376 | 324 |
| 22 | Unknown | — | — | 308 | 364 | 382 | 374 |
| 23 | 2-Pentyl furan | 416 | 368 | 384 | 319 | 387 | 401 |
| 24 | Furfuryl alcohol | 3651 | 2835 | 2787 | 2858 | 2608 | 2735 |
| 25 | Trimethyl pyrazine | 221 | 239 | 250 | 222 | 230 | 251 |
| 26 | 1-Methyl-1H-pyrrole- | 411 | 474 | 550 | 532 | 381 | 487 |
| | 2-carboxaldehyde | | | | | | |
| 27 | N-(2-Cyanoethyl)-pyrrole | 138 | 127 | 90 | 61 | 112 | 127 |
| 28 | Benzene acetaldehyde | 100 | 135 | 139 | 127 | 144 | 118 |
| 29 | 1-(1H-pyrrole-2-yl)- | 155 | 209 | 222 | 125 | 136 | 146 |
| | ethnaone | | | | | | |
| 30 | 1-(1-Methyl-pyrrole- | 145 | 127 | 128 | 109 | 123 | 126 |
| | 2-yl)-ethanone | | | | | | |
| 31 | Unknown | 354 | 384 | 294 | 285 | 332 | 396 |
| 32 | Unknown | 440 | 302 | 390 | 339 | 321 | 318 |
| 33 | 2-Methoxy phenol | 456 | 332 | 387 | 314 | 322 | 315 |
| 34 | Unknown | 251 | 160 | 304 | 254 | 183 | 155 |
| 35 | 3,5-Diethyl-2-methyl | 84 | 85 | 78 | 72 | 76 | 88 |
| | pyrazine | | | | | | |
| 36 | 1-(2-Furanyl methyl)- | 435 | 467 | 611 | 540 | 493 | 458 |
| | 1H-pyrrole | | | | | | |

As can be confirmed in FIG. 2 and Table 1, in the case of the Robusta species coffee, there was an increase in the content of 3-methyl butanal (peak no. 4) and 2-methyl butanal (peak no. 5), which are sweet and nutty malty flavor and chocolate flavor, in the direction from the control group (A) to low-temperature germination (B), enzyme-added germination (C), and enzyme-addition after low-temperature germination (D). Additionally, the coffee prepared by saccharide- and enzyme-added germination (E and F) showed a significant increase in the content of 3-methyl butanal and 2-methyl butanal, compared to the control group (A).

In particular, unidentified components represented by peak nos. 13, 21, and 22 are nutty flavor components and were discovered only in the coffee prepared by enzyme-treatment of Robusta green coffee beans (C to F).

Additionally, all the treated groups (B to F) showed a decrease in the content of 2-methoxyphenol (peak no. 33), which is a representative material for a burnt smell and a disinfectant smell, and 2-furanmethanol (peak no. 12) and furfuryl alcohol (peak no. 24), which represent a harsh smell and a bitter taste, compared to the control group (A). Additionally, there was a significant decrease of furan (peak no. 1), which is known to have a potential health risk, in all the treated groups (B to F), compared to the control group (A).

There results could be obtained not only form Robusta coffee but also in Arabica coffee (FIG. 3 and Table 2).

TABLE 2

| | | Arabica Coffee (Product of Brazil) GC Peak Area | | | | | |
|---|---|---|---|---|---|---|---|
| | | Control | | | Prep. Ex. 3 | Prep. Ex. 4 | Prep. Ex. 5 |
| | | Group | Prep. Ex. 1 | Prep. Ex. 2 | Enzyme-addition | Sugar- and | Sugar- and |
| | | Control | Low-temp | Enzyme-added | after Low-temp | Enzyme-added | Enzyme-added |
| Peak | | Group | Germination | Germination | Germination | Germination 1 | Germination 2 |
| No. | Compound | (A) | (B) | (C) | (D) | (E) | (F) |
| 1 | Furan | 270 | 246 | 230 | 213 | 235 | 235 |
| 2 | Unknown | 204 | 294 | 547 | 510 | 287 | 423 |
| 3 | Unknown | 500 | 462 | 498 | 527 | 621 | 605 |
| 4 | 3-Methyl butanal | 379 | 781 | 1662 | 1894 | 1081 | 1415 |
| 5 | 2-Methyl butanal | 824 | 1111 | 1734 | 1650 | 1446 | 1658 |
| 6 | Unknown | 392 | 359 | 227 | 296 | 308 | 254 |
| 7 | Unknown | 126 | 102 | 282 | 275 | 159 | 122 |
| 8 | Unknown | 195 | 125 | 100 | 101 | 131 | 124 |
| 9 | Unknown | 264 | 257 | 96 | 29 | 167 | 147 |
| 10 | Dihydro-2-methyl- | 127 | 167 | 73 | 97 | 110 | 86 |
| | 3(2H)-furanone | | | | | | |
| 11 | 2-Methyl pyrazine | 487 | 513 | 311 | 276 | 435 | 319 |
| 12 | Furfural | 2361 | 2776 | 2575 | 2672 | 2528 | 2485 |
| 13 | Ethyl benzene | 74 | 72 | 80 | 96 | 97 | 84 |
| 14 | 2-Furanmethanol | 2195 | 2553 | 1517 | 1458 | 2258 | 1961 |
| 15 | Unknown | 127 | 186 | 558 | 561 | 64 | 168 |
| 16 | 2-Furfurylformate | 479 | 500 | 287 | 316 | 428 | 363 |
| 17 | 1-(2-Furanyl)-ethanone | 935 | 1123 | 634 | 597 | 912 | 735 |
| 18 | 2-Ethyl pyrazine | 405 | 461 | 305 | 280 | 317 | 339 |
| 19 | 2,3-Dimethyl pyrazine | 115 | 114 | 155 | 158 | 230 | 89 |
| 20 | 3-Methyl-2-buten-1-ol | 60 | 55 | 52 | 50 | 44 | 48 |
| 21 | Benzaldehyde | 79 | 124 | 71 | 77 | 108 | 110 |
| 22 | Unknown | 1814 | 2497 | 1736 | 1929 | 1954 | 1929 |
| 23 | Unknown | — | — | 941 | 880 | 950 | 1150 |
| 24 | Unknown | — | — | 361 | 326 | 550 | — |
| 25 | 2-Pentyl furan | 157 | 132 | 157 | 157 | 175 | 203 |
| 26 | Furfuryl alcohol | 2508 | 2036 | 1802 | 1766 | 2173 | 1973 |
| 27 | Trimethyl pyrazine | 196 | 156 | 337 | 306 | 136 | 99 |
| 28 | 1-Methyl-1H-pyrrole- | 296 | 378 | 316 | 296 | 317 | 314 |
| | 2-carboxaldehyde | | | | | | |
| 29 | N-(2-Cyanoethyl)-pyrrole | 74 | 73 | 40 | 39 | 65 | 153 |
| 30 | Benzene acetaldehyde | 96 | 126 | 100 | 103 | 133 | 123 |
| 31 | 1-(1H-pyrrole-2-yl)- | 138 | 159 | 111 | 135 | 116 | 147 |
| | ethnaone | | | | | | |
| 32 | 1-(1-Methyl-pyrrole- | 117 | 141 | 43 | 78 | 66 | 45 |
| | 2-yl)-ethanone | | | | | | |
| 33 | Unknown | 288 | 252 | 205 | 99 | 199 | 114 |
| 34 | Unknown | 215 | 216 | 199 | 199 | 230 | 179 |
| 35 | 2-Methoxy phenol | 143 | 106 | 126 | 114 | 101 | 120 |
| 36 | Unknown | 164 | 168 | 169 | 196 | 150 | 104 |
| 37 | 3,5-Diethyl-2-methyl | 60 | 49 | 36 | 29 | 46 | 32 |
| | pyrazine | | | | | | |
| 38 | 1-(2-Furanyl methyl)- | 264 | 321 | 348 | 311 | 341 | 441 |
| | 1H-pyrrole | | | | | | |

That is, in the case of Arabica coffee, there was an increase in the content of 3-methyl butanal (peak no. 4) and 2-methyl butanal (peak no. 5), which are sweet and nutty malty flavor and chocolate flavor, in the direction from the control group (A) to low-temperature germination (B), enzyme-added germination (C), and enzyme-addition after low-temperature germination (D), whereas 2-furanmethanol (peak no. 14) and furfuryl alcohol (peak no. 26), which represent harsh and bitter taste components, decreased as a whole. In contrast, the unidentified nutty flavor component, represented by peak no. 15, was also discovered in the control group (A), but it was further increased in low-temperature germination (B) and significantly increased in coffee prepared by enzyme-treatment of green coffee beans (C and D). Additionally, unidentified nutty flavor components represented by peak no. 23 and 24 were discovered only in coffee prepared by enzyme-treatment of green coffee beans (C to F).

From the foregoing, it was confirmed that coffee prepared by low-temperature germination, germination by enzyme-addition, enzyme-addition after low-temperature germination, and saccharide- and enzyme-added germination of green coffee beans showed an increase in nutty malty and chocolate flavors while showing a decrease in components for a burnt smell, a disinfectant smell, a harsh smell, and a bitter taste. Accordingly, it was confirmed that the method of pretreating green coffee beans according to the present invention can improve the quality of coffee flavor while reducing carcinogens contained therein, and thus can be very effectively used in the coffee industry.

### Example 3

### Result of Sensory Evaluation of Flavors and Tastes

### 3-1. Result of Sensory Evaluation of Robusta Coffee

Sensory evaluation was performed by providing a panel of 15 people with coffee extracts of 6 different species of Robusta coffee (Vietnam) (control group (A), low-temperature germination (B), enzyme-added germination (C), enzyme addition after low-temperature germination (D), saccharide- and enzyme-added germination 1 (E), saccharide- and enzyme-added germination 2 (F)) shown in Table 1. The sensory evaluation on coffee was performed in such a manner that the evaluation on flavors regarding four different kinds of coffee aromas (nutty, sweet, harsh, and rubbery flavors) was performed first and then the evaluation on tastes regarding four different kinds of coffee tastes (bittemess, sourness, sweetness, and astringency) was performed. The result of each sensory evaluation is shown in Table 3.

TABLE 3

| | | Result of Sensory Evaluation of Robusta Coffee (Vietnam) | | | | | |
|---|---|---|---|---|---|---|---|
| | | | | | Enzyme-addition | Sugar- and | Sugar- and |
| | | Control | Low-temp | Enzyme-added | after Low-temp | Enzyme-added | Enzyme-added |
| | | Group | Germination | Germination | Germination | Germination 1 | Germination 2 |
| Type of Flavors | | (A) | (B) | (C) | (D) | (E) | (F) |
| Aroma | nutty | 4.14 | 4.93 | 5.69 | 5.85 | 5.89 | 5.85 |
| | sweet | 2.46 | 3.08 | 4.00 | 4.12 | 4.81 | 4.85 |
| | harsh | 5.57 | 4.71 | 4.53 | 4.62 | 4.45 | 4.73 |
| | rubbery | 5.29 | 4.50 | 4.00 | 3.89 | 4.13 | 3.74 |
| Taste | bitter | 6.27 | 5.00 | 5.20 | 5.15 | 5.37 | 4.92 |
| | sour | 3.36 | 3.00 | 3.29 | 3.52 | 3.73 | 3.64 |
| | sweet | 2.07 | 2.21 | 2.29 | 2.81 | 3.02 | 2.96 |
| | astringent | 4.40 | 4.00 | 4.20 | 4.12 | 4.05 | 4.01 |

As a result, as can be seen in Table 3, regarding the flavors of Robusta coffee, nutty and sweet flavors increased in the direction from control group (A) to low-temperature germination (B), enzyme-added germination (C), enzyme addition after low-temperature germination (D), and saccharide- and enzyme-added germination 1 (E), whereas negative flavors, such as harsh and rubbery flavors, generally decreased in the same direction.

Additionally, regarding the tastes of Robusta coffee, sweetness increased in the direction from control group (A) to low-temperature germination (B), enzyme-added germination (C), enzyme addition after low-temperature germination (D), and saccharide- and enzyme-added germination 1 (E), whereas bitterness and astringency decreased in the direction from control group (A) to enzyme-added germination (C), enzyme addition after low-temperature germination (D), saccharide- and enzyme-added germination 1 (E), and low-temperature germination (B). As a result of the overall sensory evaluation, positive factors for quality flavor, such as a nutty aroma, a sweet aroma, and a sweet taste and a sour taste which are either not present or weak in Robusta coffee increased, whereas negative factors, such as a harsh aroma, a rubbery smell, a bitter taste, and an astringent taste, showed a general trend of decrease in the same direction. The results of sensory evaluation were generally in consistent with the flavor analysis result (Table 1) and the pH analysis result showing acidity (Table 4) obtained using analytical devices.

TABLE 4
Result of pH Measurement of Robusta Coffee (Vietnam)

| | | | Enzyme-addition | Sugar- and | Sugar- and |
|---|---|---|---|---|---|
| Control | Low-temp | Enzyme-added | after Low-temp | Enzyme-added | Enzyme-added |
| Group | Germination | Germination | Germination | Germination 1 | Germination 2 |
| (A) | (B) | (C) | (D) | (E) | (F) |
| 5.64 | 5.53 | 5.41 | 5.40 | 5.38 | 5.37 |

### 3-2. Result of Sensory Evaluation of Arabica Coffee

Sensory evaluation was performed by providing a panel of 15 people with coffee extracts of 6 different species of Arabica coffee (Brazil) (control group (A), low-temperature germination (B), enzyme-added germination (C), enzyme addition after low-temperature germination (D), saccharide- and enzyme-added germination 1 (E), saccharide- and enzyme-added germination 2 (F)) shown in Table 2. The sensory evaluation on coffee was performed in the same manner as in Example 3-1, and the result is shown in Table 5.

TABLE 5

| | | Result of Sensory Evaluation of Arabica Coffee (Brazil) | | | | | |
|---|---|---|---|---|---|---|---|
| | | | | | Enzyme-addition | Sugar- and | Sugar- and |
| | | Control | Low-temp | Enzyme-added | after Low-temp | Enzyme-added | Enzyme-added |
| | | Group | Germination | Germination | Germination | Germination 1 | Germination 2 |
| Type of Flavors | | (A) | (B) | (C) | (D) | (E) | (F) |
| Aroma | nutty | 5.00 | 5.47 | 6.07 | 6.13 | 6.17 | 6.08 |
| | sweet | 3.64 | 4.57 | 4.79 | 4.80 | 4.95 | 4.85 |
| | harsh | 4.47 | 3.87 | 4.13 | 4.21 | 4.11 | 4.18 |
| | rubbery | 4.29 | 3.93 | 4.29 | 3.78 | 3.82 | 3.89 |
| Taste | bitter | 4.53 | 4.21 | 3.45 | 3.22 | 3.78 | 3.85 |
| | sour | 5.07 | 4.80 | 6.67 | 6.94 | 6.42 | 6.12 |
| | sweet | 2.87 | 3.33 | 3.60 | 3.84 | 3.92 | 3.87 |
| | astringent | 3.47 | 3.13 | 2.80 | 2.61 | 2.68 | 2.64 |

As can be seen in Table 5, as in the case of Robusta coffee, Arabica coffee showed an increase of positive factors for flavor quality (i.e., a nutty aroma, a sweet aroma, a sweet taste, and a sour taste) in the direction from control group (A) to low-temperature germination (B), enzyme-added germination (C), enzyme addition after low-temperature germination (D), and saccharide- and enzyme-added germination 1 (E), whereas negative flavors (i.e., harsh aroma, rubbery aroma, bitter taste, and sour taste), generally decreased in the same direction. The results of sensory evaluation were generally in consistent with the flavor analysis result (Table 2) and the pH analysis result showing acidity (Table 6) obtained using analytical devices.

TABLE 6
Result of pH Measurement of Arabica Coffee (Brazil)

| | | | Enzyme-addition | Sugar- and | Sugar- and |
|---|---|---|---|---|---|
| Control | Low-temp | Enzyme-added | after Low-temp | Enzyme-added | Enzyme-added |
| Group | Germination | Germination | Germination | Germination 1 | Germination 2 |
| (A) | (B) | (C) | (D) | (E) | (F) |
| 5.06 | 5.03 | 4.86 | 5.01 | 4.92 | 4.95 |

From the above, it was confirmed that the coffee prepared by low-temperature germination, enzyme-added germination, enzyme addition after low-temperature germination, and saccharide- and enzyme-added germination has an increase in positive factors for flavor quality while having a decrease in negative factors. Accordingly, the method of pretreating green coffee beans of the present invention can improve both flavor and taste of coffee and thus can be very effectively used in the coffee industry.

### Example 4

### Internal Physical Change of Pretreated Green Coffee Beans

For the measurement of physical changes in the interior of pretreated green coffee beans, the images of roasted coffee after the pretreatment in Example 2-3 were observed under an electron microscope.

As a result, it was confirmed that the roasted Robusta coffee (Vietnam), which was prepared by low-temperature germination (B) or by enzyme-added germination (C), has more uniform pores and thinner pore walls than the coffee of the control group (A) as shown in FIG. 4. Further, it was confirmed that the roasted Arabica coffee (Brazil), which was prepared by low-temperature germination (B) or by enzyme-added germination (C), has more uniform pores and thinner pore walls than the coffee of the control group (A) as shown in FIG. 5, as is the case with the Robusta coffee.

These results suggest that the coffee samples prepared by low-temperature germination or by enzyme-added germination have more uniform pores and a larger number of pores thus capable of capturing more flavor components and also have an improved extraction efficiency due to thinner pore walls.

Conclusively, from the above, it was confirmed that coffee, which was prepared by low-temperature germination, by enzyme-added germination, by enzyme-addition after low-temperature germination, and by saccharide- and enzyme-added germination, has more flavor components captured therein and improved extraction efficiency. Accordingly, the method of pretreating green coffee beans of the present invention can improve both flavor and taste of coffee and thus can be very effectively used in the coffee industry.

From the foregoing, a skilled person in the art to which the present invention pertains will be able to understand that the present invention may be embodied in other specific forms without modifying the technical concepts or essential characteristics of the present invention. In this regard, the exemplary embodiments disclosed herein are only for illustrative purposes and should not be construed as limiting the scope of the present invention. On the contrary, the present invention is intended to cover not only the exemplary embodiments but also various alternatives, modifications, equivalents and other embodiments that may be included within the spirit and scope of the present invention as defined by the appended claims.

1. A method for pretreating green coffee beans, comprising:
(a) germinating water-absorbed green coffee beans in an incubator or a dark room at a temperature from 10° C. to 20° C. or from 40° C. to 60° C. for 1 day to 3 days; and
(b) drying the green coffee beans germinated in step (a).

2. The method of claim 1, wherein, in step (a), the green coffee beans absorb water of the range from 40% to 60% relative to the total weight of the green coffee beans.

3. The method of claim 1, wherein, in step (b), the green coffee beans are dried to have the water content of the range from 8% to 14%

4. The method of claim 1, wherein, in step (b), the green coffee beans are dried at a temperature from 35° C. to 70° C.

5. The method of claim 1, wherein, in step (a), an enzyme is added to water before the green coffee beans absorb water, and the enzyme is absorbed into the water-absorbed green coffee beans.

6. The method of claim 1, wherein, in step (a), at least one selected from the group consisting of sucrose, glucose, and fructose is added to water before the green coffee beans absorb water, and the at least one selected is absorbed into the water-absorbed green coffee beans.

7. A method for pretreating green coffee beans, comprising:
(a) germinating water-absorbed green coffee beans in an incubator or a dark room at a temperature from 10° C. to 20° C. for 1 day to 3 days;
(b) germinating the green coffee beans germinated in step (a) in an incubator or a dark room at a temperature from 40° C. to 60° C. for 1 day to 3 days; and
(c) drying the green coffee beans germinated in step (b).

8. The method of claim 7, wherein, in step (a), the green coffee beans absorb water of the range from 40% to 60%.

9. The method of claim 7, wherein, in step (c), the green coffee beans are dried to have the water content of the range from 8% to 14%.

10. The method of claim 7, wherein, in step (c), the green coffee beans are dried at a temperature from 35° C. to 70° C.

11. The method of claim 7, wherein, in step (a), an enzyme is added to water before the green coffee beans absorb water, and the enzyme is absorbed into the water-absorbed green coffee beans.

12. The method of claim 7, wherein, in step (b), the germinating is performed after adding an enzyme to the green coffee beans germinated in step (a).

13. The method of claim 7, wherein, in step (a), at least one selected from the group consisting of sucrose, glucose, and fructose is added to water before the green coffee beans absorb water, and the at least one selected is absorbed into the water-absorbed green coffee beans.

14. The method of claim 1, further comprising washing the green coffee beans before step (a).

15. The method of claim 1, further comprising sterilizing the green coffee beans before step (a).

16. The method of claim 15, wherein the sterilizing is performed by a method selected from the group consisting of UV, plasma treatment, and a combination thereof.

17. Green coffee beans pretreated by the method of claim 1.

18-20. (canceled)

21. The method of claim 7, further comprising washing the green coffee beans before step (a).

22. The method of claim 7, further comprising sterilizing the green coffee beans before step (a).

23. Green coffee beans pretreated by the method of claim 7.
